(19) United States
(12) Patent Application Publication
(10) Pub. No.: US 2013/0066951 A1
(43) Pub. Date: Mar. 14, 2013

(54) COMMUNICATION SYSTEM AND METHOD FOR MANAGING DATA TRANSFER THROUGH A COMMUNICATION NETWORK

(71) Applicants: Aharon Agranat, Mevasseret Zion (IL); Larry Rudolph, Brookline, MA (US); Noam Sapiens, Rehovot (IL)

(72) Inventors: Aharon Agranat, Mevasseret Zion (IL); Larry Rudolph, Brookline, MA (US); Noam Sapiens, Rehovot (IL)

(73) Assignee: YISSUM RESEARCH DEVELOPMENT COMPANY OF THE HEBREW UNIVERSITY OF JERUSALEM, Jerusalem (IL)

(21) Appl. No.: 13/510,101

(22) PCT Filed: Nov. 18, 2010
(86) PCT No.: PCT/IL10/00968

§ 371 Date: Nov. 19, 2012

Related U.S. Application Data
(60) Provisional application No. 61/262,249, filed on Nov. 18, 2009.

(51) Int. Cl. G06F 15/16

(52) U.S. Cl. 709/203; 709/217

(57) ABSTRACT

A communication system is presented for managing data transfer via a communication network. The communication system comprises a server system connected to a plurality of client systems via a first management network of said communication network. Such first management network may for example be operable as multi-hops network. The server system is configured and operable to be responsive to data pieces from the client systems via said first management network, to selectively switch between first and second modes of operation. In the first operational mode, the server system manages and executes data transfer to and from the client systems through the first management network. In the second operational mode, the server system operates to manage direct data transfer between the client systems via a second data network of said communication network connecting the client systems between them. The second data network may for example be operable as ad-hoc circuits.

### FIELD OF THE INVENTION

This invention is in the field of data communication networks and relates to a communication system and method for managing data exchange between devices communicating via the network.

### BACKGROUND OF THE INVENTION

Communication or interconnection networks, which are programmable systems that transport data between nodes, are generally of many different types differing in such main factors as topology, routing and data flow control. Topology is defined by an) arrangement of nodes (terminals, or system computer components) and channels (a direct connection between two nodes) in the network, and depends on the system application, the number of system nodes, packaging and other technology restrictions (e.g. number of ports per node, wire lengths etc.). Most current interconnection networks have a multi-hop based topology, in which a path between two nodes is defined as an ordered set of channels, where the input to the first channel is the source node and the output of the last channel is the destination node. Routing provides a path finding in the topology. More specifically, routing involves selecting a path from a source node to a destination node. The routing algorithm, that is responsible for this decision, usually chooses the shortest path (typically measured by the number of hops) when possible, and balances the load on the different channels in the network (i.e. spreading network traffic as evenly as possible over all available channels). Most, if not all, current interconnection networks use packet switching for routing information through the network. Data is segmented into packets of predetermined size, the packets are then added some management information (e.g. source and destination node identification). Packets are sent over the network and are routed through each node in the network according to the routing algorithm. When all packets arrive at the destination node, they are combined together to make the original piece of data. Flow control is the management of network resources.

Storage area networks (SAN's) possess some of the greatest challenges for interconnection networks. SANs are mainly used today for backup, archiving, recovery, and for maintaining large databases and enabling frequent updates to the databases. As technology advances some more progressive applications arise, such as video libraries on demand and network TV. SAN utilizes a special-purpose interconnection scheme which enables computer systems to view remote storage devices as local. Its primary goal is to transfer data between computer systems and storage elements and vice versa. For that function it consists of a communication infrastructure and a management layer, which organizes connections, storage elements and computer systems to optimize data transfer. The communication infrastructure is a high speed network that allows for any-to-any connection across the network. It is built using interconnection elements such as routers, gateways, hubs, switches and directors.

FIG. 1 schematically illustrates the topology and routing of a SAN based communication system. A top level structure of such system is formed by client devices i (small scale computer systems that are basically the user interface), servers (which run applications as well as manage client requests and other application related operations), and storage devices (logical units capable of storing data, usually of a large scale). The connection between the clients and servers is usually based on LANs, and the connection between the storage devices and the servers is the SAN.

The performance of most digital systems, SANs included, is limited by their communication, mainly due to the bandwidth limitation. Most current interconnection networks, especially above the board level, use fiber optic communication.

US 2006/159456 describes a method for providing a storage area network. This method includes receiving, at a data storage node, data from a number of storage area network (SAN) servers via associated local nodes coupled to an optical network. The data is received at a plurality of transmitting wavelengths, where each local node is assigned a different transmitting wavelength. The method also includes storing the received data at the data storage node and sending acknowledgement messages to SAN servers to indicate receipt of the data. The acknowledgement messages are sent via the local nodes at a single receiving wavelength and each local node is configured to receive this receiving wavelength. The method may also include receiving, at the data storage node, a request for data stored at the data storage node from any of SAN servers via the associated local node at the assigned transmitting wavelength of the associated local node. Furthermore, the method may include sending the requested data from the data storage node to the requesting SAN sever via the associated local node at the receiving wavelength.

### GENERAL DESCRIPTION

There is a need in the art for a novel technique for data exchange between communication devices connectable to an interconnecting/communication network. This need is associated mainly with the inventors' understanding of a problem associated with transfer of large amount of data using the conventional packet switching approach.

Packets traffic in a network is very efficient due to the fact that a packet occupies only a single channel at any given moment. There is no complete path reserved for the packet to go from its source to its destination. When a packet arrives at an intermediate node it is routed according to the routing algorithm that takes into consideration the current traffic of other packets in the network (usually only in the closest vicinity of the said node) and the destination of the packet. The route for the packet is not predetermined and could change from one packet to the next even if the source and destination of the packets are the same. To be more specific, the rout of a single packet itself is not determined before transmission of the packet but is selected “on the fly”, such that every node of the network transmits a received packet to the free next node in the direction of the destination of the packet, but the direct route is not predetermined. Such a network is similar to a so-called “multi-hops” network used in wireless communication. Typically, communication devices communicate with one another via a base station (server).

However, with the packet switched networks, which assume fixed network architecture (wireless and/or wired-based), increasing the bulk data size will cause an increase in the number of the packets required to be sent. This in return will cause network congestions and therefore decrease performance. Furthermore, since each packet requires appropriate structural bytes additions (e.g. headers), the total overhead increases linearly with the number of packets. The performance of the network is also dependent on the number of nodes in the network. An increased number of devices connected to the network typically lead to an increased number of packets to be sent and thus decrease performance in the same manner

In order to overcome the problem of network congestion and alleviate the restriction on system performance when transferring large amount of data, the present invention provides a novel approach utilizing integration of two different routes/modes of data transmission, and selectively switching between these modes based on a predetermined condition of specific data. One route corresponds to the server operation to implement the conventional packet switching based data transfer mode. The other route includes direct transmission of data via a different type data network, e.g. optical communication network, managed by the same server. To this end, the server operates to determine the destination address for the task required and allocate an address to the source and destination and thus enable direct data transmission between the source and destination. The address determination process could either be static, where the nodes in the network have a predetermined address, or dynamic where the address is assigned to a node according to network requirements.

Thus, the present invention provides a novel communication system utilizing communication network architecture for connecting one or more server systems with plurality of clients and for enabling direct connection between the clients. It should be understood that the terms “server” and “client” used herein refer to communication systems/stations (generally, software and/or hardware utilities) where “server” provides clients with network services (via “client-server communication session”) including also services defined by the functional features of the invention, while “client” may or may not be a “server” of another communication network. In other words, for the purposes of the present application, a “client” is any system/device receiving network services from the “server”. The communication system of the invention utilizes the conventional packet switching network (e.g. LAN), termed herein “management network”, for connecting clients to the server, and an additional network, termed herein “data network” (wireless and/or wired-based), directly connecting the clients between them. The additional network operates to selectively establish so called “ad-hoc circuits” for communication between clients, i.e., circuits established for a specific purpose/task/session. These circuits allow direct communication between the clients. Both the management network (“multi-hops”) and the additional data network (“ad-hoc circuits”) may be based either on wired or on wireless communication, or a combination of both.

Considering the specific example of SAN, storage devices are constituted by some of the clients; the data network establishes direct connection between clients to allow direct transmission of data between the clients and the storage devices and from the storage devices to the clients.

Generally, the data network allows direct transmission of data between every pair of network clients, being storage devices or other client types. A server system of the communication system of the present invention may be normally in the second mode of operation in which it operates inter alia for managing usage of the data network by assignment of addresses relating to actions to be executed and does not take active part in the data transfer itself. In this mode, the server operated to establish ad-hoc circuits for direct communication between clients for execution of specific tasks. Upon identifying a predetermined condition in a data piece (request) coming from a client, the server system switches to the first mode and operates by itself to execute an action of data transfer (e.g. packet switching action). When in the second operational I mode, the server system has a dominant role in managing the direct data exchange between the clients (e.g. the client and storage device): the server system manages the data transfer, nevertheless it does not serve as a mediator for the data traffic nor does it have anything to do with the data content, which it does when in the first operational mode. The data, about which a decision is made as to whether to transfer it via the first or second networks is termed herein “main data” to distinguish it from data pieces received by the server and forming a basis for decision and/or data pieces returned from the server to the clients being notification messages for management commands or instructions regarding execution of direct communication between the clients.

The server system and one or two service LANs (management network) form a complete centralized management mechanism, which in the first mode of the server operation enables dynamic allocation of data paths, and dynamic allocation of ad-hoc circuits (network nodes and connection between them) when in the second operational mode. This architecture facilitates operation of high data volume transfer through the communication network, especially when data storage is considered.

More specifically, the invention is used with storage device and is therefore described below with respect to this specific but not limiting example. Thus, the term “storage device” used herein below should be interpreted as “client” (sometimes termed “element” of the network) connectable to the network via “client-server communication session”. Also, the term “device” should not be limited to any single-computer station, but rather should be interpreted broadly as any communication utility, e.g. formed by one or more computers or database systems.

It should be noted that the communication system of the present invention may be used with a Storage Area Network (SAN) and is exemplified herein as a SAN-based network, while the communication system of the present invention may generally be used with any other type of communication network. For example, the present invention may be used for High Performance Computing grid network (HPC) or any other server based communication network.

The data network, connecting the client and storage devices between them by establishing ad-hoc circuits between pairs of clients, may be in a form of a closed loop connection (e.g. data ring) connecting all client and storage elements of the network, while each of these elements is independently operable as a client of the management network. The data network allows parallel transmission of different data pieces between different elements of the network while without interaction between different data pieces. As indicated above, the data network may be wired-based network, or wireless network or a combination of both. These may be computer and/or phone networks.

As indicated above, the data network may be an optical communication network, in the form of a wavelength addressing data loop. Such network utilizes optical fiber bundles carrying data on top of Wavelength Division Multiplexing (WDM) communication protocols. For simplicity and to enhance the understanding of the invention, the data network will be described further on as being an optical fibers network. It should however be understood that, for the purposes of this invention, the data network or data ring may be of any kind of coded information carrying network, which allows direct connection between the transmitter and receiver elements (by dedicated addressing of the nodes) and allows parallel transmission of different data pieces directly between different network elements upon assignment of proper circuits, e.g. address/channels, by the server.

The data transfer via the data network may be based on wavelength addressing. In this concept, the circuit assigned to a receiving client device (destination), as well as a transmitting client device (source) of the network is a specific wavelength in which the devices communicate (transmit and receive data). Such a circuit may be constituted by a wavelength-fiber pair. A wavelength-fiber pair is a combination of the carrying wavelength and information of a fiber within fiber bundle through which the data is to be received. The general principles of wavelength addressing are known and therefore) need not be described in details, except to note that this technique is based on the fact that many wavelength channels can reside comfortably in the same fiber without cross talk between the channels. This is because the different wavelengths do not (normally) interact. The invention utilizes assignment of a fiber (propagation path) for a certain wavelength. For simplicity of the description, such assignment is sometimes referred to a “fiber-wavelength pair”.

Each of the client devices, connected to the communication system of the present invention, is typically assigned with a permanent address for use within the management network (“multi-hops” network). This address is typically similar to an IP address used in computer networks. According to the invention, the client device is also assigned, or may be assigned according to the operation scheme of the server system, with another network identification or address for use for communication through the data network (e.g. “ad-hoc circuits”). It should be understood that with regard to data network, the circuit is assigned or may be assigned to the client device in the meaning that the corresponding addresses (source and destination) may be static, such that the device is pre-assigned with an address, or dynamic, such that the server allocates addresses to corresponding devices according to the specific task or session to be performed at each time. In this connection, it should be understood that a task may be single- or multi-session, as well as a session may be associated with single or multiple tasks. It should be noted that each client device has a management network address in order to be considered “client” for the purposes of the invention, i.e. to communicate using the communication system of the invention. Such management network address is permanent, in the meaning that it is assigned to a client device regardless of the device's participation in any specific data transfer. However, dynamic allocation of provisional circuit in the data network means that a client device is assigned with an additional address for participating in a specific data transfer, i.e. data transfer that has been classified by the server as one involving the data network. It should be noted that the term “provisional circuit” or “ad-hoc circuit”, at times referred to as “circuit”, is used herein in the meaning of a network address used for direct communication between a pair of client devices/systems through the data network. These terms are therefore at times referred to as “data network address”.

Thus according to one broad aspect of the invention, there is provided communication system for managing data transfer via a communication network, the communication system comprising a server system connected to a plurality of client systems via a first management network of said communication network, said server system being configured and operable to be responsive to data pieces from the client systems via said first management network to selectively switch between first and second modes of operation such that in the first operational mode the server system manages and executes data transfer to and from the client systems through the first management network and in the second operational mode the server system operates to manage direct data transfer between the client systems via a second data network of said communication network connecting the client systems between them.

In some embodiments of the invention, the server system comprises a manager utility for managing communication between the multiple client systems via said first and second networks of said communication network, and a data network controller. The manager utility comprises: a data receiver module for receiving data pieces from the client systems, and an analyzer module. The latter is configured for analyzing each of the received data pieces and identifying whether the data piece corresponds to either one of first and second data types to be treated by either one of the first and second operational modes of the server system with respect to transfer of data corresponding to said data pieces through the communication network, such that in the first operation mode, the server operates to transmit main data corresponding to the data piece through said first management network according to a network address embedded in said data piece, and in the second operational mode the server operates to initiate transfer of main data corresponding to said data piece via the second data network connected to said first management network. The data network controller is configured and operable to be responsive to output of the analyzer module to establish assignment of the main data to be transferred to a dedicated channel in said second data network.

The server communication with the client system may utilize a permanent address of the client system in said first management network, while the servers system may manage communication between the clients via the second data network using additional addresses assigned to the client systems in the second data network.

Preferably, the data network controller is configured and operable to establish the assignment of the main data to the dedicated channel by assignment of a provisional circuit in the data network to source and destination client systems, thereby allowing said direct communication between the source client system and the destination client system. The data network controller may be configured and operable to establish the assignment of said provisional circuit in a static mode, such that each client system connected to said server system has its pre-assigned provisional data circuit. Alternatively or additionally, the data network controller is configured and operable to establish the assignment of said circuit in a dynamic mode in response to the received data piece, for the transfer of the main data corresponding to said data piece. The data network controller may be responsive to a notification regarding said transfer of data, for releasing a previously assigned provisional circuit after completion of said transfer of the main data.

In some embodiments of the invention, the data network controller is configured and operable for controlling data transmission via an additional dedicated network connecting some of the network client systems.

In some embodiments of the invention, the analyzer module identifies whether the received data piece corresponds to either one of the first and second data types according to at least one predetermined condition including a condition corresponding to a volume of the main data, which in accordance with said received data piece, is to be transferred.

In some embodiments, the first management network is configured as a storage area network, in which case at least some of the client systems comprise data storage utilities.

Preferably, the second data network is of a kind configured as a multi channel network capable of parallel transmission of different pieces of main data between different client systems of the communication network. As mentioned above, the data network may utilize the principles of a static addressing network and/or dynamic addressing network, the server system is configured and operable to assign an address to the client system in the second data network.

In some embodiments, the data network comprises an optical communication network. The optical communication network comprises an optical fiber network, the main data being transferred between the client systems by wavelength addressing. The optical communication network may comprise a bundle of optical fibers, an address assigned to a client system may be constituted by a selected wavelength-fiber pair.

According to another broad aspect of the invention, there is provided a communication device connectable to a communication network via a server system, the communication device comprising: an electronic utility comprising: a port configured for connecting to a first management network of the communication network, a processor utility, a memory utility; and receiver and transmitter module configured for receiving and transmitting data to and from a second data network of said communication network; said processor utility of the electronic utility being preprogrammed for selectively transmitting or receiving data via the first or second networks according to a notification message received at the electronic utility through the first network.

The receiver and transmitter modules may communicate via said data network according to a data network provisional circuit of said client device, while said circuit/address may be static or dynamic. The receiver and transmitter modules may be assigned with a data network provisional circuit in response to said notification message.

The transmitter and receiver modules may be configured and preprogrammed for dynamically allocating provisional data circuit according to online circuit switching scheme.

In some embodiments, the electronic utility comprises a manager utility preprogrammed for prioritizing different data transfer sessions relating to different notification messages to execute said data transfer sessions through either the management network or the data network according to a predetermined scheme.

In some embodiments, the receiver and transmitter modules may be connectable to said data network being an optical data network, in which case the device may include a wavelength allocation module for selectively transmitting optical signal in a predetermined wavelength range. The receiver module selectively receives optical signals in said wavelength range. The device may further include a tunable light source for transmitting optical radiation in a wavelength determined by said processor utility, via said data network. Alternatively or additionally, the wavelength allocation module is connected to an optical power grid. The latter may for example be configured as a laser power grid as described in U.S. Pat. No. 7,715,714, assigned to the assignee of the present application and incorporated herein by reference in connection with this specific example. The wavelength allocation module inputs optical radiation from said optical power grid in a wavelength which corresponds to said notification message.

According to yet further aspect of the invention, there is provided a method for managing data transfer through a communication network, the method comprising: receiving data from a remote communication device via said communication network, identifying whether the received data satisfies a predetermined condition, and classifying the data accordingly, said predetermined condition defining a threshold value for a volume of main data; and based on said classifying, generating a corresponding notification message to said remote communication device indicative of a manner in which main data, corresponding to said received data, is to be transmitted by the communication device, thereby enabling selective transmission of the main data via first or second networks of said communication network.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates the topology of a conventional communication network constituted by a SAN based network;

FIGS. 2A and 2B illustrate an example of communication network architecture of the present invention, exemplified for a SAN-based network;

FIG. 3 shows a flow chart of a method carried out by a server system within communication network architecture of the present invention;

FIGS. 4A and 4B show flow charts of two example of the invention: the server's operation for managing a client initiated task (FIG. 4A), and a server operation for managing a server initiated (or automatic initiated) task (FIG. 4B);

FIG. 5 illustrates another example of a SAN-based communication network architecture of the invention;

FIG. 6 shows an example of a wavelength addressing data loop used in an embodiment of the invention;

FIGS. 7A and 7B illustrate two examples of transmitter/receiver modules for use at a client connectable to a communication network of the invention utilizing wavelength addressing data loop;

FIGS. 8A and 8B show schematically an optical power grid and an optical switch for use in a wavelengths addressing communication network according to the invention, FIG. 8A schematically illustrates an optical power grid connected to a plurality of client devices, FIG. 8B schematically illustrates an optical power switch for coupling/decoupling optical signal from an optical fiber; and

FIGS. 9A to 9F, 10A to 10C and 11A to 11D illustrated simulation results comparing the data transfer through the communication network configured according to the invention (formed by SAN-based management network and an optical data network) and the conventional SAN-based network.

### DETAILED DESCRIPTION OF EMBODIMENTS

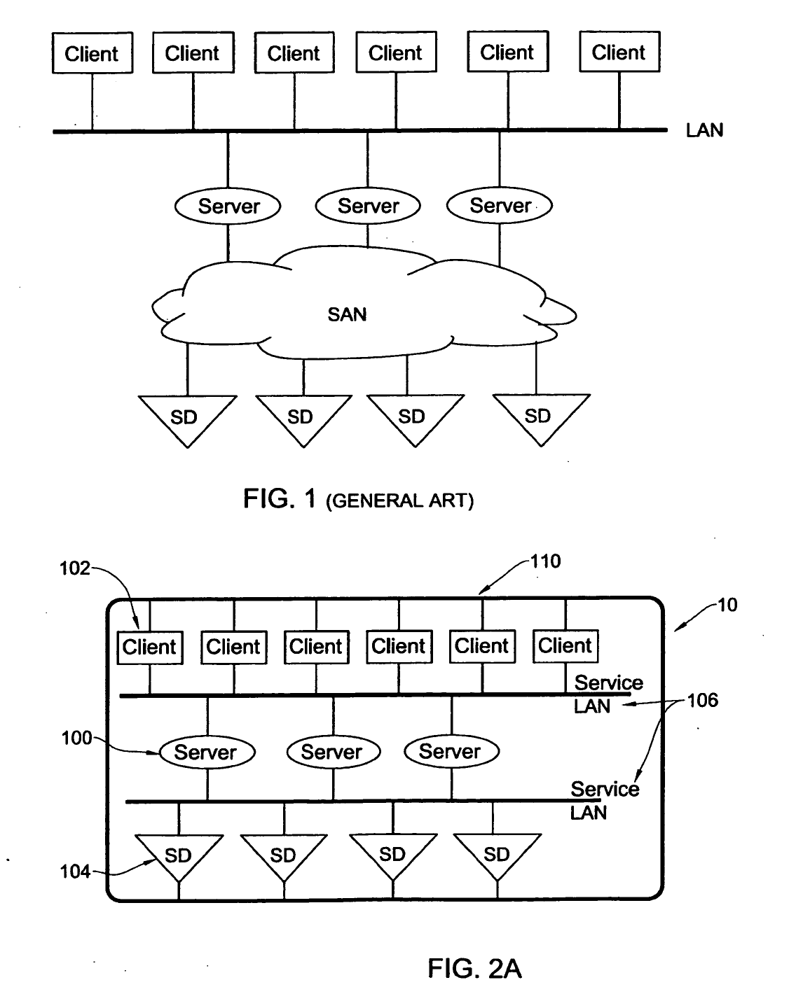

FIG. 1 schematically illustrates the configuration and operation of the conventional SAN-based system. As indicated above, in the known SAN-based systems a connection between the clients and servers is usually based on LANs, and the connection between the storage devices and the servers is the SAN (storage area network). The connection scheme is usually such that no direct connection between the storage devices and the clients exists.

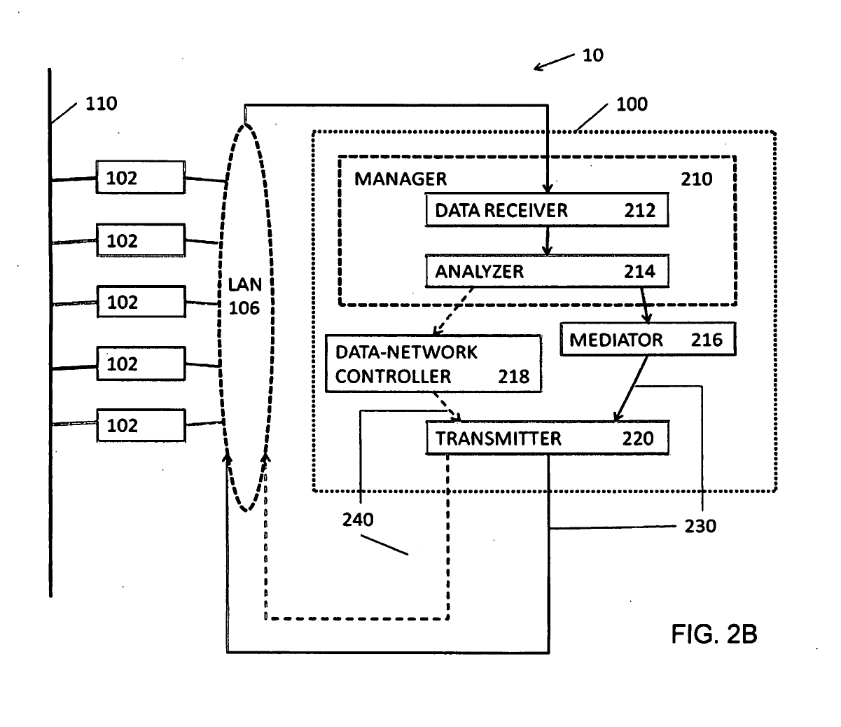

Reference is now made to FIG. 2A illustrating, by way of a block diagram, an example of a communication system 10 implemented with a communication network architecture of the present invention. As indicated above, the present invention is exemplified hereinbelow with the SAN-based technology, although the principles of the invention are not limited to the SAN-based topology of the network, and the invention can be used with any other communication network for exchanging data between the network nodes/elements. To facilitate understanding of the invention, FIG. 2A illustrates the system invention in a manner similar to the illustration of the conventional system in FIG. 1.

The system 10 includes multiple server utilities, generally at 100, and multiple client utilities, generally at 102, communicating between them via the network architecture of the invention. In a SAN-based network some of the clients are storage devices 104 providing storage of data for backup and/or later extraction of data. The network architecture in the system 10 includes two different-types, independently managed and operable, networks, designated 106 and 110. The first network 106 (typically LAN) connects the clients to the servers for data transfer between the clients via the servers. The second network 110 directly connects the storage devices and the clients (generally, connects the clients) between themselves for direct data transfer between them while managed by the servers.

Generally, in a communication network, client is any device communicating with the network (i.e. other clients) via the server. In the specific SAN-based example, the clients are usually PCs or other small scale computer systems that run specific applications; such clients may also be servers of another network, external to the specific SAN. The clients are thus connected to the SAN servers through a traditional connection such as a LAN. Servers are computer systems that supply common application services to other computers in the network. Servers could be either mainframe computers, which are single monolithic multi-processor high performance computer systems (at least relatively to the rest of the system) or a group of distributed computers clustered together for dedicated common application services access. In any case, the predominant characteristic of a server is the multiple I/O connections and their high performance. In SANs, servers connect to multiple clients and storage devices and run common applications for clients, storage devices and networks (both LAN and SAN). These applications might include any high level applications that are the purpose of the system, management protocols and scheduling tasks. The servers are responsible on managing traffic within the network and scheduling tasks performing.

Reference is now made to FIG. 2B illustrating, by a way of a block diagram, an example of a communication network according to the invention, showing more specifically an example of the configuration of a server system. To facilitate understanding, the same reference numbers are used for identifying components that are common in all the examples. The communication network 10 includes a server system 100 associated with a management network and with a data network. The server system 100 is connectable to a plurality of clients 102 via the management network 106. The multiple clients are connected between them via the data network 110 for direct data transfer. The servers system can thus selectively manage the data transfer in the data network via communication with respective clients by the management network. The server system includes a manager utility 210, a mediator utility 214, data network controller 218, and a transmitter 220. The server system also includes a data receiver 212 and an analyzer 214. It should be understood that all these elements are implemented as software/hardware utilities, the functional modules of which will be described further below.

The manager module/utility 210 is configured to receive data pieces or task requests via the management network 106, analyze this incoming information and decide in which of the operation modes the data is to be further treated by the server system. Accordingly, the manager module 210 includes a data receiver 212 which is connected to the management network 106 and receives data pieces transmitted via the management network; and an analyzer 214 which analyzes the received data piece to make a decision about the operation mode. To this end, the analyzer determines whether the received data piece corresponds to an action request (e.g. “RETRIEVE CERTAIN DATA FROM STORAGE DEVICE”), management information (e.g. “RELEASE CERTAIN CIRCUIT OF DATA NETWORK”, meaning that data retrieval at said provisional data circuit has been completed), or data packet (“main data”) transmitted via the management network 106. In case the data piece is identified as a request for action to be carried out at the communication network 10, the analyzer 214 decides, according to predetermined conditions/criteria, as to whether to execute said request through the management network 106 (first operation mode) or to initiate execution of the request through the data network 110 (i.e. instruct/notify the respective clients to act to implement direct data transmission between the relevant clients 102 through the data network). It should be understood and will be described further below that the client device is installed with a corresponding manager utility which is responsive to such notifications/commands from the server system to redirect the data to the data network.

Based on the decision making, the analyzer 214 operates according to its first or second operation modes. At the first operation mode, the analyzer directs said data piece to the mediator 216. Such data piece, which is treated in the first operation mode, may be one of the following: a request for task that was chosen to be executed via the management network 106, or management related information, or a successive data packet corresponding to the main data that has been previously classified for transmission via the management network 106. The mediator 216 forwards the relevant data to client(s) according to address(es) in the management network. The mediator transmits the main data 230 to the transmitter 220 for transmitting it via the management network 106.

In case the received data piece is classified to be treated according to the second operation mode (i.e. via the data network 110), the analyzer 214 transmits the request details to the data network controller. 218 which is preprogrammed for managing transmission of data via the data network. Such data piece, which is treated in the second operation mode, is that corresponding to transmission of “main data”. The data network controller 218 assigns provisional circuits to relevant clients within the data network 110, and possibly also prioritizes tasks to be executed, as well as deal with various conflicts which may occur, as will be described below. The data network controller 218 transmits notification data 240 (such as a provisional circuit assigned to certain client, a command to initiate data transmission, or an address release command) to the transmitter 220 for transmission of a corresponding notification message to the client via the management network 106. In such case only management commands (e.g. in the form of notification messages) are transmitted via the management network while in the second operation mode, while the main data related to the execution of the request is transmitted directly between the clients via the data network 110.

Thus, a communication network according to the present invention, for example a SAN-based network (has clients and storage devices in a similar manner as in regular SAN-based networks), is formed by two different types of networks: a first, management network, and a second, data network. The management network is configured and operable as a regular communication network, such as LAN. According to the invention, this management network is operable for at least transmitting requests for actions to be executed (e.g. transmission or receiving of some data) and action-related data, such as the data network addresses (provisional circuit) assigned to the client initiating the request and a destination-client, type of data to be transmitted/received, instructions for an action to be taken another clients, etc. As for “main data”, i.e. data to be exchanged between different clients, the management network is selectively used for transmission of such data, as will be described below. The second network 110 is a data network through which “main data” is selectively transmitted. This data network 110 has a closed-loop connection (a so-called “data ring”) that interconnects the storage devices and the clients directly between them, and is used for the main data transfer. This data network 110 is preferably based on a wavelength addressing concept which will be described in details below. The operation of the data network 110 is managed by the server system 102 of the management network. Thus, according to the invention, the server system 102 has a modified role with greater emphasis on network management. Thus, the clients 102 are connected to the server system through the management network (LAN) 106 and are connected between them by the data ring 110. The management network provides a communication platform for management messages (request-related data) between the server system 100 and the clients 102, and sometimes (as will be described below) is used for the main data transfer, while most of the main data travels through the data loop 110 directly from the clients 102 to the storage devices 104 and vice versa. The direct data transmission via the data loop 110 does not utilize the server system 100 as a mediator for data transfer but is managed by the server system via the data network controller 218 (and a corresponding manager utility at the client side). This management includes a decision making of whether to actuate the data transfer through the data loop 110 and assignment of pairs of dedicated channel connections between the respective clients.

As indicated above, the data loop 110 may be a wavelength addressing loop, and may utilize optical fibers that carry multiple wavelength channels each corresponding to a different network address, i.e. a specific circuit between two client devices. Thus, in this case, the server system assigns a fiber-wavelength pair for the requested action to be executed.

Generally speaking, in the system of the invention, each of the devices connected to the communication network has a LAN address for communication through the service LAN (management network 106), and is assigned, or intended to be assigned an additional address for communicating through the data network 110, i.e. provisional circuit.

The data network 110 may be a static addressing network, where an address is assigned to each of the devices connected thereto in order to establish circuits belonging to the client devices for direct communication, or it may be a dynamic addressing network, where such circuits (addresses) are assigned to network devices by the server for execution of a requested task. Static addressing has the advantages of management simplicity and therefore enhanced network performance. This is because no address assignment algorithms and procedures are required to be multiple times executed by the server, since each node (device) already holds its own address. On the other hand, this implementation limits the number of nodes to the number of addresses available in the system. Dynamic addressing has the advantages of scalability and a possibility to connect a higher number of deices to the data loop because there could potentially be more nodes than addresses. The number of nodes may exceed the number of addresses to some extent, without causing performance degradation. For example, the number of addresses may be 50%, or 20%, or even 10% of the number of nodes. Dynamically addressed nodes have fixed virtual addresses that serve as the nodes identification in the global system management scheme, i.e. in the management network. When a circuit between a source node and a destination node is required (according to a predetermined condition as will be described below), based on the nodes virtual addresses, the management mechanism in the server system assigns the destination node with an address and then allocates the same address to the source node to complete the circuit.

The predetermined condition defining selection of either one of the management network 106 or data network 110 for the main data transfer may be with respect to a volume of main data to be transferred. More specifically, the server system analyses the requested action to identify whether the data volume to be transferred according to this request exceeds a predetermined threshold or not. In case the data volume exceeds the threshold, the server operates in the second mode to initiate the direct data transfer between the clients being involved. The server system may also base the data analysis on other parameters, such as security considerations, task priority and/or a risk of errors during task execution. To this end, the server system assigns and actuates, or actuates the previously assigned, address for the data transfer.

The selection of threshold for the data volume is such that service related data and some of the small scale communication data is transferred in packets via the service LAN 106 (first operation mode of the system of the invention), while tasks which require transfer of large amount of data is executed through the data network 110. Such tasks may be, for example, backup of data from a certain client to one or more storage devices or retrieval of data from one or more storage devices to a client. The server system utilizes internal algorithms for decision making about the routing of data to be executed via the LAN 106 or via the data network 110. The server system also typically considers data transfer related conflicts and scheduling of different tasks, as will be described below. In case the server routs the task of data transfer to the data network, it assigns address to the relevant devices so that the data can be transferred via the respective channels of the data network. The algorithms used may vary by cost-efficiency designs and quality of service schemes for the system.

Communication between devices may be shifted to the data network 110 according to the following scheme: When a task is initialized, either by a client device by sending a message/request via the LAN to the server, or by a server itself, the server identifies the conditions of the execution of the task. These conditions include the data transfer involved (e.g. amount of data) and preferably parameters or conditions of the LAN 106 and/or data network 110 (load of the network), and/or a number of requests/actions associated with the same receiving or transmitting device, etc. Based on this analysis, the server system decides (based on predefined criteria) whether the information transmission needed for the specific task is to be executed via the service LAN 106 or routed to be transmitted directly between the relevant devices via the data network 110. In the case the server routs the task to be executed via the data network 110, the server sends a management message via the service LAN 106 to the relevant clients and/or storage devices. Once this message is received, the respective device sends proper acknowledgements back to the server system as a way of mitigating allocation of resources and ensuring procedural integrity. The server system then assigns an address within the data network to the relevant pair of client devices and generates corresponding notification, thus allowing direct data transfer between the devices via the data network 110. When the data transfer is completed, at least one of the relevant devices notifies the server system accordingly, via the service LAN 106, and the assigned address might be released.

It should be understood that when transmission of relatively low amount of data is considered, the execution of the second operation mode is not need. This is because of the following: The second operation mode requires transfer of notification messages via the management network 106. Such notification messages themselves might cause load on the management network. Therefore, these notification messages can be replaced by transmission of the corresponding low-volume main date. The use of the data network 110 for the main data transmission is efficient for tasks involving transfer of relatively large volumes of data.

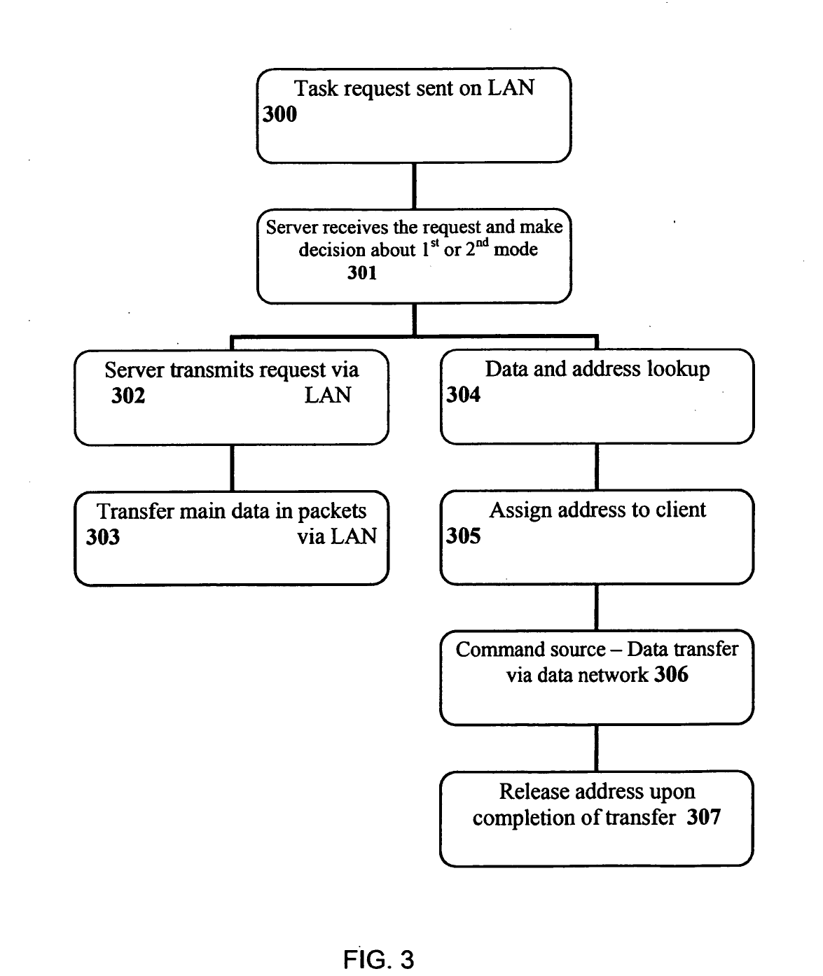

Reference is made to FIG. 3 illustrating an example of a method of the operation of the server system according to the invention. This figure illustrates a schematic flow chart of task execution through the network, and relates to an example dealing with client generated task. A client generates a request and transmits it via the LAN (step 300) aimed at initiating a task to be executed at the network (e.g. “RETRIEVE DATA FROM STORAGE DEVICE”). This request includes information about at least the data that should be transferred (and possibly also some identification of the information source). The task request is received by a server which operates as described above to classify the request (according to parameters such as the amount of data transfer needed for completion of the task) and decide whether to treat the task with the first or second mode (step 301), i.e. execute related main data transfer via the LAN in the conventional packets routing manner or initiate the task execution via the data network.

The server's decision may relay on information included within the client's request, or it may require lookup within storage devices. Tasks involving transfer of main data of a volume smaller than a predetermined threshold are executed via the LAN by the main data transmission in packets (steps 302-303). If the transfer of main data volume involved in the task is larger than the predetermined threshold, the server routs the task to the data network via the respective client. To this end, the server performs a search stage (step 304), in which it performs lookup of the data needed for the task (i.e. searches for respective client/storage device), and looks for a free address in the data network. This stage may also include various management tasks done by the server such as prioritizing the task, conflict management and other QoS management. In order to execute the task, the server assigns the “requesting” client and the other client (e.g. source”) with appropriate address (e.g. fiber-wavelength pair) in the data network 305 and notifies the involved clients about said address. A command/notification message is sent to the respective client, e.g. to the “source” to begin the data transfer via the relevant channel of the data network to the “requesting” client or generally “destination” client (step 306). When the data transfer is complete, the destination client informs the server and the assigned address is released (either by the server or by the client or by distributed software utility). For example, the server releases 307 the address in its record to be used for another task.

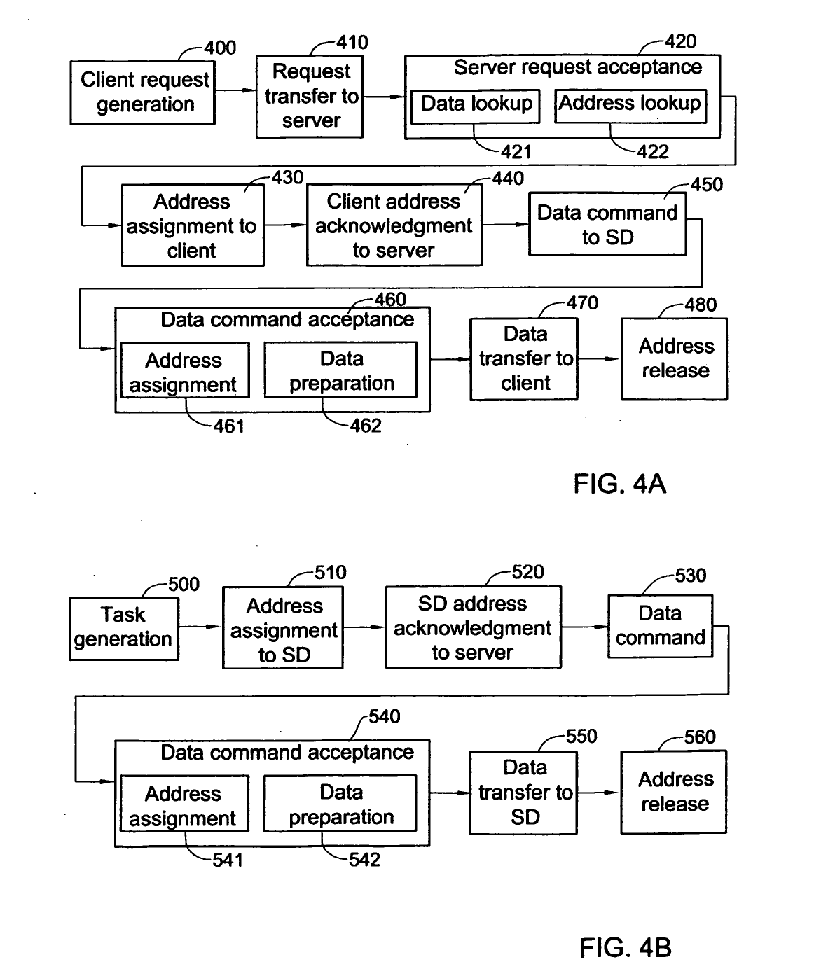

Reference is now made to FIGS. 4A and 4B showing, in a way of block diagrams, the operation of a server system of the present invention, for executing two different examples of data tasks involving data traffic in large volumes, i.e. transmission of a large-volume main data. The examples correspond to data retrieval (FIG. 4A) and backup of data (FIG. 4B). These two tasks differ in the way they are initiated. Data retrieval is usually initiated by a client device (i.e. executed in response to a request originated by the client), while backup is usually a scheduled task which is initiated by a server. It should be understood that the above mentioned tasks are only an example of the tasks executed within the network. It should also be understood that, generally, any task may be initiated either by a client or be scheduled and generated by a server regardless of its standard nature, for example, a user may wish to perform backup independently to the scheduled backup performed regularly. In such a case, the task will be initiated by a client device and not by a server. It should also be understood that the principles of the invention and the configuration of the system of the invention is neither limited to any specific task nor to a type of task initiator.

FIG. 4A shows the main steps in executing data retrieval in a network according to the present invention. When a client device requires a certain piece of data from a storage device, it generates a corresponding request message (step 400), either automatically via an API installed in the client device or by user actuating said API. This request is transferred to the server through the service LAN (step 410). The request message is formatted according to the communication protocol governing the service LAN. When the server receives the request, it performs one or more procedures (stage 420) that include at least data lookup (step 421). Data lookup consists of searching for a virtual address of the storage device (another client) on which the requested data is available and possibly also a local address (location) of said data within that storage device. This process could be done in cooperation with an existing SAN system to be used as data lookup query center. Optionally, the server then performs some management operations (prioritizing, conflict management and other QoS management) to organize the request process. When the request is to be processed (e.g. per the predefined prioritizing), the server looks for an available provisional circuit (e.g. fiber-wavelength pair, wavelength address) in the data network (step 422). The server then operates to send a notification message about this address to the client, via the service LAN (step 430). Optionally, the process is such that, when the client assumes the given address, it sends an acknowledgement back to the server (step 440). As was mentioned earlier, the system may or may not be a so-called “acknowledgement based” system to ensure process integrity and correct resource allocation. In some embodiments, upon receiving the acknowledgement from the client or a certain time after transmission of the notification message (as the case may be), the server sends a data command or notification message to the storage device to initiate data transmission therefrom to the requesting client (step 450). Alternatively, the system protocol may be such that the requesting client, upon receiving notification from the server about the relevant storage device and the address, initiates communication with the storage device and requests the data therefrom. The data command to the storage device, coming either from the server or from the requesting client, includes the data location or the data description (for an onsite storage device lookup), and the same address that was assigned to the requesting client. The storage device then accesses the data and prepares it according to the communication protocols of the data network (step 460), such as encoding, data integrity, error detection, etc. The storage device then sends the data via the data loop using the appropriate address for the requesting client (step 470). The storage device might be inclined to send an acknowledgement to the server of the fact that the transmission has started, according to the service requirements of the server. When the storage device completes the transmission, it resets the address allocation device (to indicate no address allotted) and sends an acknowledgement to the server. According to the system service protocol, the server either waits for the client to acknowledge the end of the transmission, in which case the client releases its assigned address automatically, or sends the client an address release message. In the first case, the client is notified that the data transmission has terminated successfully. Moreover, by receiving the message from the client, the server can release the address in its records, thus ending the task. In the second case, the server informs the client that the transmission has terminated and that the address should be released. The client then releases the address and sends an acknowledgement to the server. Only when the server receives this acknowledgement, it can release the address in its records and terminate the task (step 480).

FIG. 4B shows the steps of executing a task generated by the server which is either time or event based. Time based backup is a task that is initiated according to the server clock by a certain service in that server. This type of task generation could be scheduled periodically or otherwise by the system administrator (step 500). Event based backup is performed according to some system algorithms. These could be a simple event, e.g. backup every time a client station is shut down; or a complex one, involving multi network sensing applications that are capable of indicating a system failure or an upcoming catastrophe. Task generation includes identifying the origin of the backup process and the storage destination (receiving client) for the data. The backup origin could be a client, or a storage device, in which case inter-storage direct data transfer is accommodated, or could be the server itself (or any other server for that matter), enabling server operation recovery when needed. Once the process participants (data transmitting and receiving clients) have been identified (e.g. their LAN addresses have been located), the server sends a notification message, including the address assignment information, to the destination client (storage device) using its LAN address (step (step 510). When the storage device receives this message, it considers the assigned address and sends a corresponding acknowledgement to the server (step 520). This, again, is done to ensure complete process integrity and correct allocation of resources. When the server is aware of the fact that the storage device is properly assigned, it sends a data command message to the transmitting client (data origin)—step 530. The server may hold various parameters from previous backups to indicate a more precise data transfer. The server may indicate whether all or just part of the data needs to be sent for backup. If the data origin device has never been recorded previously, or if the system is a simple one, the data for backup is chosen as the entire device data. In a more sophisticated system, when data backup of the device has been executed before by the system, the server may hold parameters such as a file version or latest modification date to eliminate numerous copies of the same data. The server may hold and manage certain database including a list of storage devices where data from a certain origin is located. This enables a server to hold both the current and the previous information for the system. An even more sophisticated system might include the possibility of deleting older versions of the same file. The data command also includes the same address as the one assigned to the destination storage device. When the data is ready to be transferred (according to the appropriate network communication protocols)—step 542, and the proper address has been allocated as the transmission address (step 541), the data is sent over the data network/loop directly to the storage device (step 550). When the transfer is complete, an address release process similar to the one described in the previous example, is performed (step 560).

As indicated above, the server system preferably treats the received task according to a predetermined management mechanism, including for example prioritizing the tasks, conflict management, etc. When a server receives a task it places that task in some form of queue. The order in which the tasks are placed in the queue dictates the resource allocation priority. Tasks are placed in the queue according to the system efficiency algorithms and QoS scheme. Whenever a conflict occurs with a task that is in the queue, it is solved by the rearrangement of the queue (according to appropriate algorithms). When a conflict occurs with a task that has already left the queue and is now in processing, a different management scheme is in order. This management scheme considers appropriate location for this task in the queue and actions to be done with the task or tasks that are currently in process.

There are three main types of conflicts to be considered: (1) there is more than one task associated (pending or processing) with the current task's data destination device, (2) there is more than one task associated (pending or processing) with the current task's data source device, and (3) there are not enough resources available for completing the task.

The first conflict type regards a case when two or more streams of data arrive at the same node at the same time. Since the streams of data collide such that the node is incapable of extracting any useful data from the intertwined streams, including the source nodes virtual addresses, this conflict should be avoided. The network architecture of the invention does not allow for “line listening”, source address detection or any other traditional way of resolving a collision. Nevertheless, the central management mechanism of the network architecture of the present invention enables prediction of this conflict and thus allows for applying a method for preventing these collisions while facilitating multiple tasks with the same destination device. The latter is desired in order to increase system efficiency. For example, let us consider the client data retrieval task. It would be a waste of valuable time for a client to await the termination of the current task before sending another request to the server. Many management operations could be performed for the new task before the previous one is finished, which will enhance the throughput of the system. Furthermore, let us consider the case that a client starts a large transfer task and then wants to send a new task with a much smaller transfer. According to the common efficiency algorithm of “shortest job first”, the new task would precede the previous one. This could be done as part of the management mechanism installed in the server. There are two distinct cases to this conflict: the conflict occurs when the source devices are the same, and the conflict occurs when the source devices are different.

When the new task and the conflicted task have the same data source device, a solution for the situation is dependent upon the technological capabilities of the devices in the system. In this case there are a few options: The source device may deal with the conflict itself Accordingly, the management of this type of conflict is distributed to the source device. The server decides whether to permit the source device to handle the conflict or to handle it by itself. Since the source device sends the data from both tasks to the same destination, it has full control over the data flow. If the source device is to manage the conflict, the source device has the required logical processing capabilities and conflict management capabilities. The first may be based on the existing device processor or a dedicated processor for it. The conflict management mechanism could be implemented in software and/or hardware. As an example, let us consider a storage device that has a cache memory attached to it and has a way of reading multiple streams (e.g. by having multiple heads in a HDD). When the server decides to let the storage device to deal with this collision, the storage device can start accessing the second task information while still sending data for the first task. When the second task information is ready, according to the proper management algorithms, it can put the first task on hold, placing the data in the cache for the time being, and start sending the information of the second task. Obviously, the client can discriminate the two streams of information (e.g. headers with the task ID). The storage device can then either alternate between the two tasks or send one after the other according to the calculated priority. As can be clearly understood, the technological capabilities along with the management algorithms definition determine the system procedures and performance.

When the source device has no technological capabilities to handle the conflict, due to the absence of logical capabilities or absence of other technological capabilities that enables handling two or more tasks at the same time, or when the multi-tasking capabilities of the source have been exhausted, the server handles the conflict. In most cases, it would be inefficient to disturb a task after the server has initiated it to the source (e.g. in HDD based storage devices, the data access time is in the order of 10msec), therefore the server may be preprogrammed to wait on the completion of the previous task before initiating the new one. However, some systems might enforce different algorithms according to the devices in the system, data transfer rates and priority and QoS schemes. In any case, the conflict will be dealt with by a decision made by the server to change the queue or the tasks that are already running.

The case where the source devices are different is more intricate. There could be one of four options as a solution: The most straight forward solution for the conflict problem is by queuing the task. This solution entails the server the sole and complete management to solve the conflict. This solution uses the tasks queue in the server to deal with conflicts. The queue is ordered according to the management and QoS algorithms. Any task that conflicts with an already running task is either placed on hold in the queue, pending the completion of the previous task or tasks, or sent to be dealt with by the underlying regular LAN, thus eliminating the conflict entirely. This solution is the simplest one, yet it is not completely wasteful. Some management procedures could be performed before the previous task or tasks are finished. In this respect, the QoS scheme of the system deals with fairness in resource allocation. For example, in a case of a request from a client, the client may keep its current address to shorten the process of the new request. The QoS scheme might be inclined to limit the number of sequential requests a client may be entitled to.

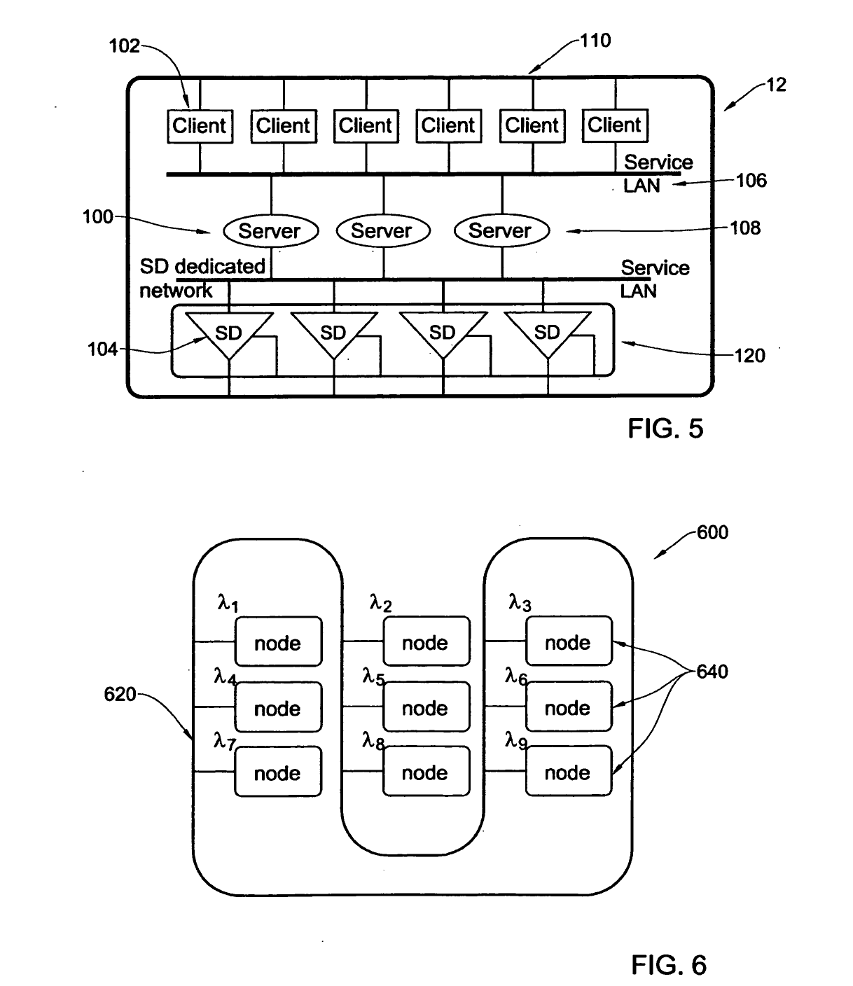

Another method for dealing with such conflicts involves connecting the storage devices between themselves by an additional dedicated network. Generally, the additional dedicated network may connect some of the client devices for use in other types of communication networks. This solution is only viable for systems where the storage devices are “smart”, i.e. capable of processing data and communicating between them. This solution to the conflict introduces a storage device dedicated network. This is schematically illustrated in FIG. 5. This figure shows a network 12 according to the invention, which is generally similar to the above-described network 10 of FIG. 2A, and also includes an additional data network 120 connecting the storage devices between them. This network is a secondary data network with multiple channels. It introduces a completely independent network that enables data transfer between different storage devices. Management of this secondary network 120 is performed by the same server systems 100 that manage the entire communication network 12, thus maintaining centralized management. The storage device dedicated network 120 may be used for better load distribution and conflict solution. It also establishes a way for storage devices to transfer data without loading the primary data network. This feature is extremely useful with storage area network systems where backup and archiving are key applications.

To better understand the function of the storage device dedicated network, let us consider the following few examples: A client may request data associated with two or more storage devices. The case may be such that the clients successively requests data from such two or more storage devices, or alternatively the server identifies that the requested data is distributed in two or more storage devices. In the first case, the sequence of the requests is defined by the clients. In the second case, the server defines the sequence of the requests. In any case, the server system 100 deals with the first request according to the system management mechanism. Upon receipt of the second request, the server may decide to instruct the second-request storage device to send the required data to the first-request storage device through the storage device dedicated network. The first-request storage device may then decide how to send the data to the client (e.g. alternating, first job first or second job first). This requires some advanced algorithms for the server (e.g. decision whether the data transmission is to be initiated simultaneously or queue the second request), as well as a more sophisticated storage device (logical functionality and multi data stream support). In another example, data may be requested to be transmitted to a storage device from more than one client, for example, in order to perform backup to the clients onto the same storage device. Due to the fact that there is no dedicated client network, the conflict could be solved by having the server organize the tasks such that the data from one of the clients is transmitted directly to the task destination storage device and data from the other client is transmitted to another free storage device. The data is then transmitted using the dedicated storage device network to the actual task destination storage device. Again, a more sophisticated management mechanism is required for this type of system, one that can control the secondary network 120 as well as the primary network 110 and coordinate between them.

One other method of solving the above conflict is time division multiplexing (TDM). TDM introduces an extra dimension to the system. Sending data over the data network not only entails selecting a channel and coding of the data but also an appropriate time slot. When two or more source nodes need to transmit their data to the same destination node they are assigned with the destination node address and each gets a time slot. The time slot length or the number of time slots allocated to each source device is discretionary to the server management mechanism. This solution might be most suitable for small scale systems or systems with an internal clock. This clock might be based on the power grid in the system.

The second type of conflict mentioned above relates to a situation where a task arrives at the server requesting communication from the same source device as an existing task. The main concern here is how many concurrent tasks a device can support. When the device can only support one process at a time or when the tasks the device is handling at a given time reaches its limit, the server is responsible for managing any new tasks to the source device. Otherwise the server may (according to the management mechanism) delegate the management of the conflict to the source device. When the destination device is the same for any two or more tasks, the solution is similar to the described above. When the destination devices are different, the source device might have the required technological capabilities that enable it to manage the solution for this conflict has two technological requirements: (1) online circuit switching is possible, and (2) the source device has switching capabilities. The first requirement means that the address allocation device is capable of changing the destination address fast enough. The second requirement means that the source device itself has the capability to change from one data stream to another (e.g. be capable to access two or more pieces of data at the same time and store them in a readily available cache memory for fast access). When a source device with these capabilities receives two or more tasks (according to the management mechanism of the server), it decides which of the tasks to deal with first and how to handle the other tasks (e.g. alternate between tasks, send the shortest task first etc. according to the appropriate management protocols). The source device can then start a specific task transmission and change the transmission to another data stream with a different destination address.

The third conflict described above results from a lack of sufficient amount of resources. When there are not enough available resources to complete a task, the management mechanism could either use one of the solutions described above for alleviating the conflict or can wait pending resource availability. It should be emphasized that the management algorithms and QoS scheme dictate the priority by which newly available resources are distributed and utilized.

As described above, in order to send data between devices through the data network, at least the destination device must be allocated with an address (e.g. fiber-wavelength pair). The address may be static and pre-allocated, but in order to enhance the scalability of the network dynamic addressing is preferred. Address allocation is a management characteristic that depends entirely on the technological capabilities of source nodes in the system. The technological parameter that influences the characteristics of the address allocation is the data access time. This time ranges from nanoseconds up to tens of milliseconds or even more in some cases. This huge span requires the management mechanism to particularly consider it when allocating resources, especially the addresses. The main problem with the data access time is the fact that it is a stochastic variable and depends on the type of the source device, the technology of the devices in the system, on whether the data was recently accessed (in which case it might still be in a cache memory or buffer), or even the location of the data in the source node (local address). There are three basic alternatives for address allocation (more complex algorithms might be adopted for actual systems):

The address allocation may be based on determining address when task is accepted. In this method, the address is guaranteed for the data communication upon the task is received and accepted for processing by the server. This way is most suitable when the data is available immediately from the source node. The address is wasted for a considerable time (the data access time at least) if the data is not readily available.

The address allocation may be based on determining address when the data is ready. In this method, the address is not wasted for the duration of the data access time. This method is therefore more preferable for cases when the data access time is long. The source node accesses the data, and when it is ready (or, better yet, when the source node predicts it to be ready) the source node sends an indication to the server. The server then sends the allocation command to the destination node and then to the source node. In this case, there might be a time waste of the management messages. Also, it might be the case that there is no available address when the data is ready, in which case the server performs the address allocation command only when an address is available.

The address allocation may be based on determining an address when request is received, but with a timeout. This method is a compromise between the two previously described ones. When a task is received by the sever, it allocates an address to the source node; if the source node does not acknowledge the use of that address until a certain time elapses, the server sends release messages to both the source and destination devices. The source node then notifies the server when the data is ready, and awaits a new allocation.

According to the management mechanism, the server may also be responsible for scheduling of tasks. Scheduling refers to the proper timing of the tasks to be executed. The server assumes the role of scheduler in several interfaces in the system, such as the client interface, where it is responsible mainly for commodity tasks; the storage device interface, where tasks that may involve the secondary storage device dedicated network and other tasks that are storage device exclusive; automatic tasks, that are initiated mainly by the server itself and are required to be executed without impediment on client nodes in the system.

Any task might have a time window assigned to it, indicating the start and end time of the task's validity (deadline management). When a task arrives at the server or is otherwise initiated, the server determines whether the task could be performed in the allotted time window. A sophisticated algorithm that includes the time windows for all received tasks and other priority based parameters is used for this decision. Tasks that could be performed according to the management mechanism criteria are placed by the server in the queue. Tasks that could not be accommodated are discarded and proper notification is sent to the task origin.

It should be noted that the management mechanism is implemented by suitable software and/or hardware modules. The management mechanism is a part of the data network controller (218 in FIG. 2B) of the server system, or implemented as distributed utility between the data network controller and client devices (e.g. via storage device dedicated network (120 in FIG. 5)).

As also indicated above, the data network is preferably an optical fiber data loop, capable of transmitting wide band of wavelengths simultaneously. The fact that the data is carried by photons enables transmission of data at very high bit rates over long distances, and the fact that the photons are trapped in the fiber is instrumental in avoiding the crosstalk that is typical to the coaxial cable in the electronic data transmission fashion. Exploiting the fact that light signals of different wavelengths do not normally interact enables transmission of many channels of data in parallel on the same fiber by using a different wavelength for each channel. This is based on Wavelength Division Multiplexing (WDM) technique for transmitting high volume of data traffic over long distances. WDM systems with 100 channels per fiber carrying 10 Gb/sec are commercially available enabling data traffic at a rate of approximately 1 Terabit per second in one fiber.

Wavelength addressing is a networking concept that utilizes WDM technology to enable direct routing of data. Each node in the network is assigned a specific wavelength that is considered its address. Data transmitted in a certain wavelength on the network is read only by the node that was assigned that wavelength as its address. A data loop based on wavelength addressing is illustrated schematically in FIG. 6. The data loop 600 is formed by a bundle of optical fibers (light guides) 620 and a set of nodes, generally at 640 which receives the data from the fibers. Each of the nodes 640 connected to the data loop 600 is configured to receive light signal of a certain wavelength λᵢ.

Wavelength addressing based architectures require nodes in the network to be capable of selectively transmitting and receiving in different wavelengths. The node hardware (HW) is either a processing element, storage device or other electronic entity in the network. This HW device receives data from the network via a certain fiber-wavelength pair. For that purpose, it has a wavelength addressing module.

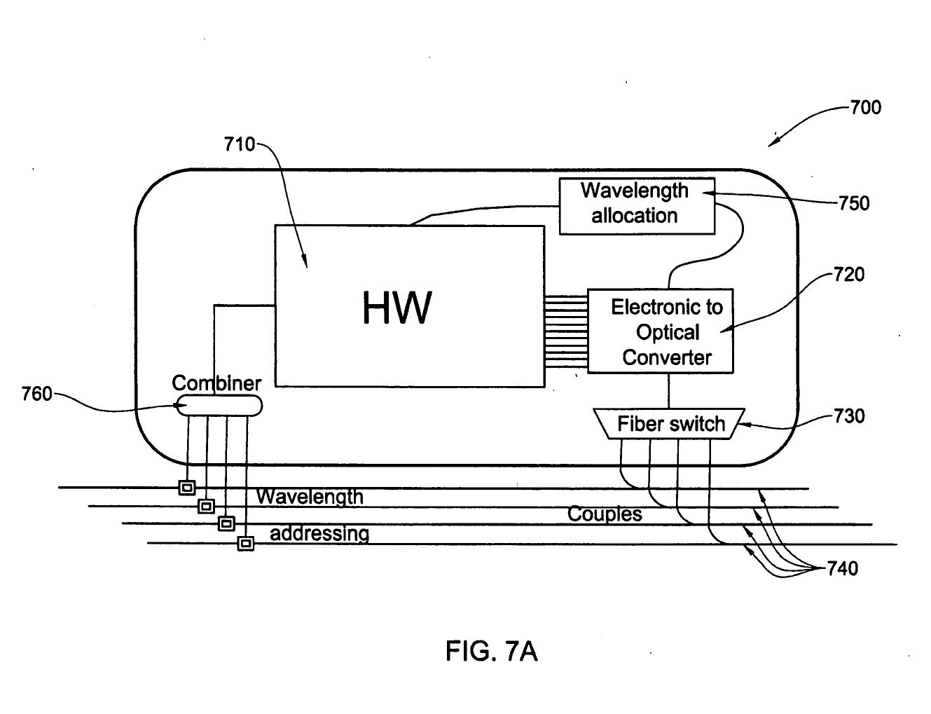

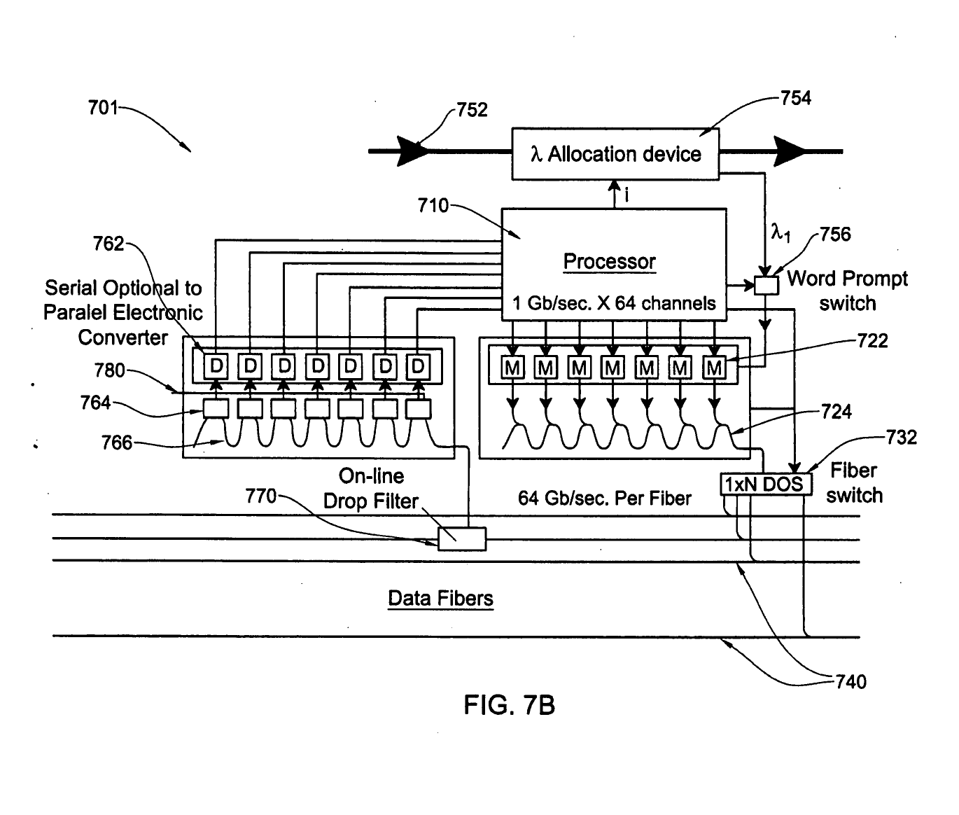

Reference is now made to FIGS. 7A and 7B illustrating an example of a transmitter/receiver module 700 at a client device configured for connection to a wavelength addressing data network. In the example of FIG. 7A, the transmitter/receiver module 700 is an electronic utility 710, being a processing unit and/or storage device. This electronic utility 710 is connected to an electronic to optical converter 720, which converts electronic messages from utility 710 to optical signal of a specific wavelength and transmits the signal through a selected optical fiber 740 using a fiber switch 730. The wavelength carrying the optical transmission is selected by a wavelength allocator 750 according to the address of the destination device, e.g. received from the server system. To this end, the client station includes a tunable light source or a plurality of light sources of different wavelengths, in both cases the light source may be constituted by light emitter(s) or by light port(s) connected to an optical power, as will be described below. The construction and operation of tunable light sources are known per see and therefore need not be described in details, except to note that such source may include a broadband emitter and a wavelength-selective filter (e.g. grating or resonator). The electronic utility 710 is preferably also connected to a splitter/combiner 760 which receives light signals from multiple optical fibers 740 according to the specified wavelength address assigned to the device, and generates a combined output signal.

Data transmission is performed in response to a command (notification) from the server, where the command includes data indicative of the wavelength-fiber pair assigned as the address of the destination device. Wavelength allocation is performed by a command from the electronic utility 710 to the wavelength allocation module 750 which then transmits a light signal of a specific wavelength into the electronic to optical converter 720. The latter converts the electronic parallel data originating from the electronic utility 710 into serial optical data to be transmitted onto one of the fibers 740. The specific fiber to transmit the data is selected by a fiber switch 730 which uses optical couplers to integrate the new data onto the stream of data on the fiber.

The electronic utility 710 may be implemented as or installed in a storage device connected to the network, or a computer used by an end user, or any other type of communication device which may need to receive or transmit data in large volumes. The electronic utility 710 is connectable to the server system via LAN by a suitable connection port (not shown in this figure). The device 710 uses the LAN for transmission of service messages to the server system such as a request for data retrieval from some storage device, a request to perform backup which was initiated by the end user, or other data transfer related requests. As indicated above, the server may execute the main data transfer via the LAN in the conventional manner. This is done when the data transfer state satisfies a certain predefined condition. The condition may be associated with the main data to be transmitted and/or the network current state. For example, if the main data associated with the request has relatively low volume, i.e. not exceeding the predefined threshold, the data is transmitted via the LAN. Another example is that the data network is unavailable due to failure or due to high load on the data network, in which case the LAN is used for any main data.

The electronic utility, being a client device, may also include a manager (processor) utility configured for the purposes of the invention. Such manager utility is preprogrammed (has an application program interface running appropriate algorithms in response to data/signals from the server). More specifically, the client manager utility is responsive to notification messages from the server, and is preprogrammed for selectively transmitting or receiving data via the management network port or via the data network port. The client manager utility is also responsive to notification messages indicating a data network provisional circuit to be used by the client device to communicate with via the data network.

As indicated above, the wavelength allocation module 750 may include a tunable laser, capable of selectively generating coherent light of a different wavelength with a relatively narrow bandwidth around this wavelength. This is in order to allow multiple devices connected to the network to exchange data via the optical data network with no or reduced cross talk between them.

The tunable laser may be based on electro-holography techniques. For example, the laser cavity may include a non-linear media, e.g. KLTN crystal, which deflects light incident thereon in accordance with an electric field applied thereto, e.g. divert certain wavelengths out of or into the laser cavity. By varying the electrical field applied on the electro-optical crystal, different wavelengths can be successively diverted into or out of the cavity, thus increasing the gain of certain wavelengths and increasing the loss of others. This configuration allows for electrical tuning of the laser output wavelength.

Each address within the wavelength addressing scheme is a wavelength around which the receiving device receives data. It should be understood that the system also takes into account a bandwidth around that wavelength which cannot be used for other addresses since it will be collected by receivers assigned to that specific wavelength. The wavelengths addresses are selected to be separated enough by wavelength bands to allow resolving of each specific wavelength without confusing it with another address.

When an address is assigned to a device, in the form of a specific wavelength in which the device receives data, the splitter/combiner 760 filters out all other wavelengths but the one specified in the address. The input optical signal is then converted to electronic signal and processed by the device 710.

FIG. 7B illustrates another example of a client device. Here, the client device or a part thereof designated 701 includes a receiver module, a transmitter module, and a processor 710. The receiver and transmitter modules are connectable to an optical fiber or a bundle of optical fibers 740 for transmitting and receiving data. The transmitter module receives raw optical power 752 from a laser source 754 (or from a power grid wavelength allocation device). Light from the laser source is coupled into the device through an electro-optic modulator 756 which produces a single pulse upon a “dispatch” signal received from the processor 710. The output of the electro-optic modulator is connected to the input of a multimode interference module (MMI). In the figure, a circuit formed by the electro-optic modulator and the MMI is designated at 756. The MMI outputs are connected to the inputs of an array of electro-optic modulators (EOMV), generally at 722. The outputs of the EOMV 722 are coupled to the Pulses Distribution Waveguide (PDW) 724, which is a single mode waveguide along which unidirectional couplers are spaced at equal distances. The distance between consecutive couplers is given by

$$d = \frac{{τ}_{E} \cdot {V}_{P}}{{N}_{b}} \qquad ( 1 )$$

where τ_{E} is the time segment between the production of consecutive words at the output of the processor 710, N_{b} is the number of bits in the digital word, and v_{P} is the velocity of propagation of the pulses in the PDW 724; d is selected so that the entire digital word is distributed in the time segment τ_{E}.

The output of the PDW 724 is connected to a 1×N digital optical switch (1×NDOS) 732. The 1×N DOS 732 is a set of single digital optical switch devices connected in series. The outputs of DOS 732 are connected to a multitude of fibers 740 that form the optical bus of the network.

The input to the receiver accepts bit serial data in the form of photonic pulses from the data fiber 740. The input coupler 770 is connected to the Pulses Distribution Waveguide (PDW) 766, which is a single mode waveguide along which electrically controlled couplers 764 are spaced at equal distances. The distance between consecutive couplers 764 is given by equations (1) above. The electrically controlled coupler may be a 1×2 optical switch. The output ports of the couplers are connected to an array of detectors, generally at 762, whose output is connected to the parallel input of the processor 710.

The operation of the transmitter module is as follows: First, the modulators in the EOMV 722 are configured by a parallel output signal of the processor 710. Thus, the first modulator is configured so that it represents the most significant bit in the digital word, the second modulator represents the next significant bit, etc. Upon the receipt of a “dispatch” pulse, an array of optical pulses enters the couplers of the PDW 724 according to the configuration of the EOMV 722. These pulses form a photonic bit serial representation of the parallel digital word produced at the output of the processor 710. The train of pulses inputs the 1×N digital optical switch 732 that routes them to the destination output fiber 740 according to the fiber-wavelength address assigned to the destination of the signal; this data is managed by the processor 710.

The receiver operates in the following manner A pulses train enters the receiver and propagates along the PDW 766 until the first pulse (representing the most significant bit of the word) reaches the furthest coupler 764 of the PDW 766. At this moment, the couplers 764 are activated by a “receive” signal 780, and the pulses are incident in parallel on their respective detectors 762. The detectors 762 produce electric signal in response to the incoming optical signal and convert the electric signals into parallel strings of digital data transmitted into the processor 710.

It should be noted that the synchronization of the “receive” signal can be accomplished by augmenting the digital word with a header segment of several long bits that are transmitted in advance of the word and activate the “receive” signal. It should also be noted that the synchronization of the “receive” signal can be accomplished by augmenting the digital word with a header segment of several slow bits in a fixed string that are transmitted ahead of the word and activate the “receive” signal. This header will be received by a “conventional” optoelectronic receiver that will recognize that a word is approaching the receiver and will generate the “receive” signal.

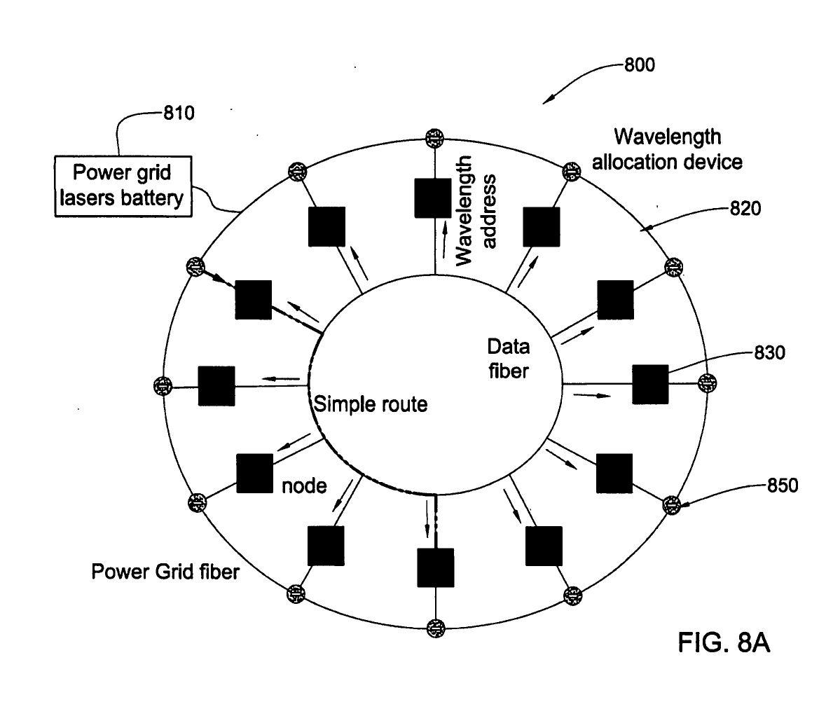

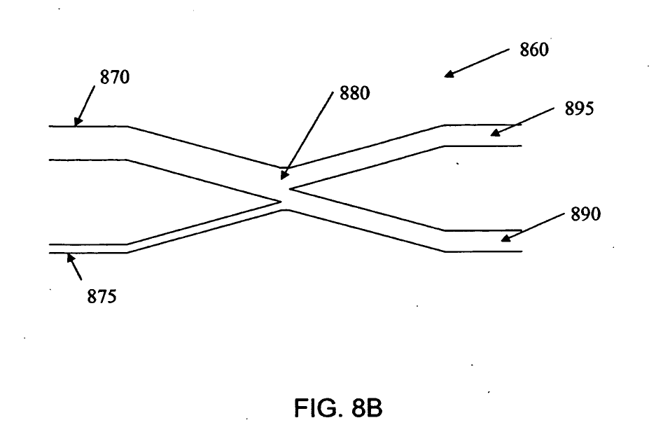

Reference is now made to FIGS. 8A and 8B illustrating an optical power grid (FIG. 8A) and an optical switch (FIG. 8B) suitable to be used for directing optical signals to the nodes.

FIG. 8A illustrates an optical power grid 800, which includes a laser battery 810, transmitting optical power in all wavelengths used by the power grid clients, connected by a power grid optical fiber 820 to a plurality of client devices 830. Each of the clients 830 is connected to the power grid optical fiber 820 by a wavelength allocation device 850 which transmits only a specific wavelength to the client 830. The clients 830 I communicate between them via an optical network (data network) 840. The use of an optical power grid 800 removes a requirement for a tunable laser is each of the clients, but on the other hand involves another connection of all the clients to a second optical fiber. The client use optical power at a specific wavelength, downloaded from the power grid for communication within the optical network.

FIG. 8B illustrates an example of an optical switch device 860 used for directing or diverting some of the optical power from a main optical fiber out and into a client of the network, and for coupling incoming optical power from a client. The optical switch has an input single mode waveguide 870 transmitting optical power along a fiber. At the switch junction 880 the fiber enters a short double-mode fiber segment which is divided into two output optical fibers 890 and 895. Another single mode input waveguide 875 is connected to the junction for coupling optical power into the fiber. An incident field in one of the input waveguides 870 and 875 is coupled into the modes of the multimode junction region, according to the geometry of the device and to refractive indices at each of the output waveguides. Adjusting the geometry of the switch and/or the refractive indices of the output waveguides allow adjustment of a ratio of optical power diverted into each of the output waveguides 890 and 895.

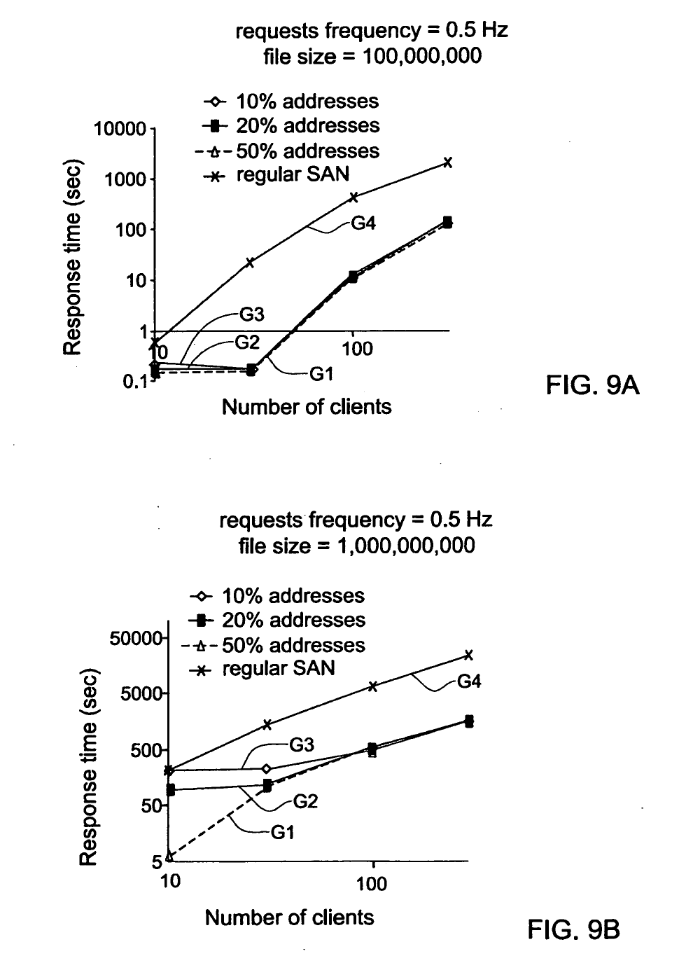

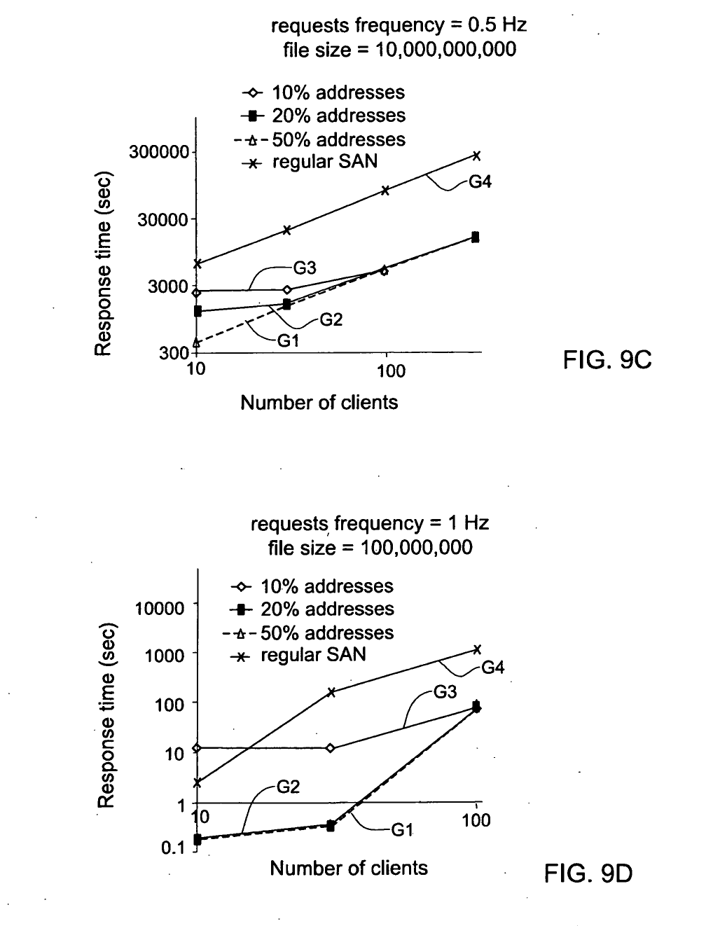

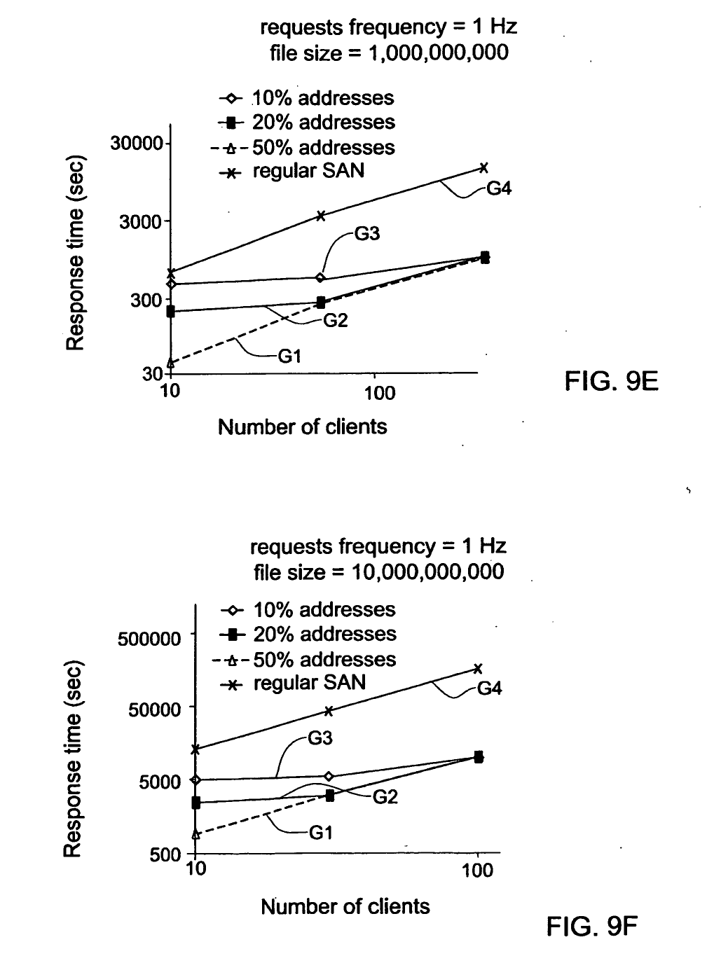

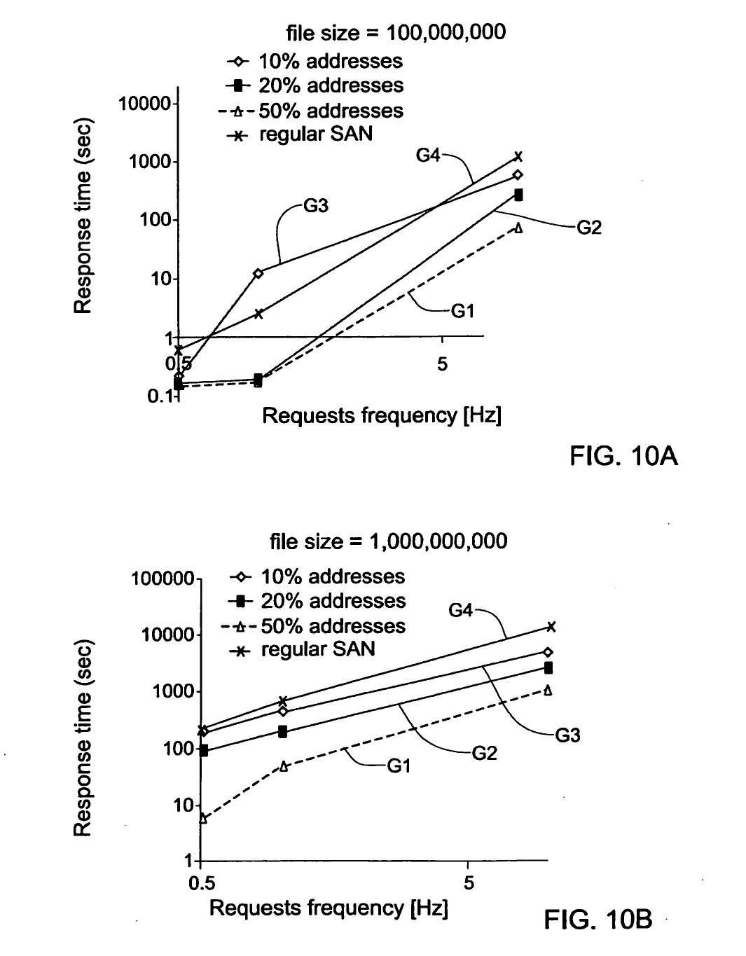

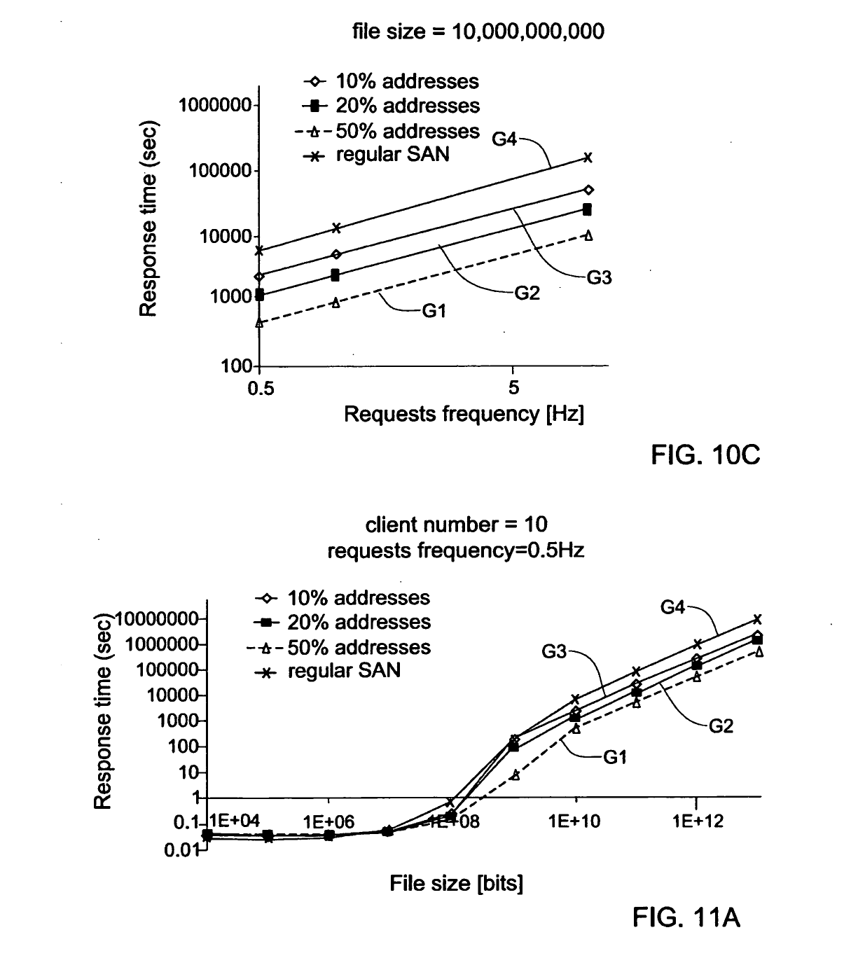

The inventors have conducted a series of simulations which show the advantages of the communication network according to the principles of the present invention. In the simulations, the inventors compared the SAN-based communication network of the invention to the conventional SAN-based network. FIGS. 9A-9F show simulation results in the form of a response time of the network as a function of number of nodes in the network, for various cases of different request frequencies and file sizes. FIGS. 10A-10C show simulation results in the form of a response time as a function of request frequency.

Each one of FIGS. 9A to 9F and FIGS. 10A to 10C show 4 graphs G1-G4. Graphs G1-G3 correspond to a network topology according to the present invention with 50% addresses (G1), 20% addresses (G2) and 10% addresses (G1) of the number of nodes. In these cases, the network includes wavelength addressing data loop. Graph G4 corresponds to a regular SAN architecture. In the figures, the graphs are presented in a log-log scale in order to illustrate the power low behavior of the system. Linear relation in a log-log scale stands for a power low relation, where a curved graph or a line with changing slop represents a change in behavior of the network.

The simulation results show that the response time obtainable with the conventional SAN-based network, presented by graphs G4 in FIGS. 9A-9F, is linearly related on a log-log scale to both the number of clients in the network and the requests frequency. This is indicative of a steady behavior function of the network in relation to these parameters. It can further be seen that the architecture of a network according to the invention, presented by graphs G1-G3, exhibits different behavior for different system configurations and applications. For smaller file sizes, the response time profile has a breaking point both for the number of clients (FIGS. 9A-9F) and for the requests frequency (FIGS. 10A-10C). With the greater file sizes, such a breaking point occurs only with regard to the number of clients, and only in some of the configurations as can be seen in FIGS. 9C, 9F and 10C, where graph G1 does not show a knee point, and graphs G2 and G3 show a knee point only in relation to the number of clients. Also, the relation between the response time and the requests frequency for larger file sizes is approximately linear on the log-log scale—see graph G1 in FIGS. 9C and 9F. It is apparent that for the case where the number of addresses in the system constitutes 50% of the number of clients (graph G1), the relation is linear on a log-log scale, i.e. the system's behavior does not change with a change of the number of clients, i.e. the system behavior is a steady function of the number of clients.

It can be seen that for small file sizes, i.e. FIGS. 9A, 9D and 10A, the slope of the response time curve for both the number of clients and the requests frequency of the network according to the invention (graphs G1-G3), is greater than that of the regular SAN-based network (graph G4). This means that for smaller file size the use of conventional SAN may be preferred for better performance. However, as the file size increases, the slopes of the system behavior decrease for both the regular SAN-based network and the network according to the invention, but not at the same rate. For example, the slope of graph G1 in FIGS. 9C, 9F and 10C is smaller than that of graph G4. The network architecture of the invention thus provides better performance transferring larger files than that of the regular SAN.

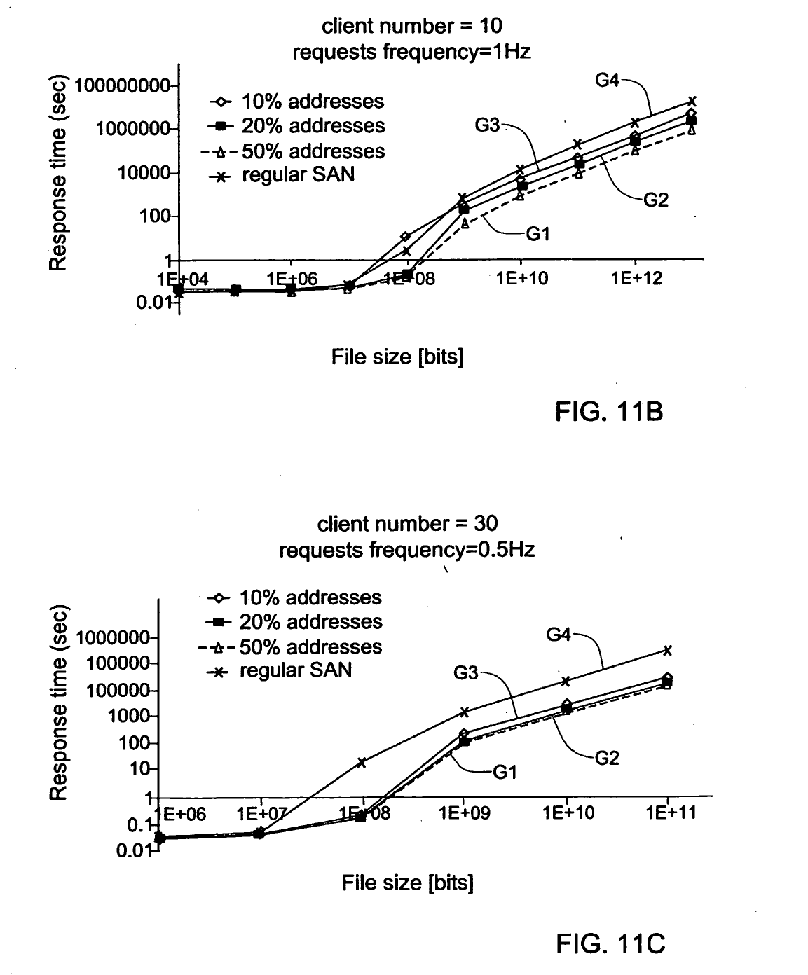

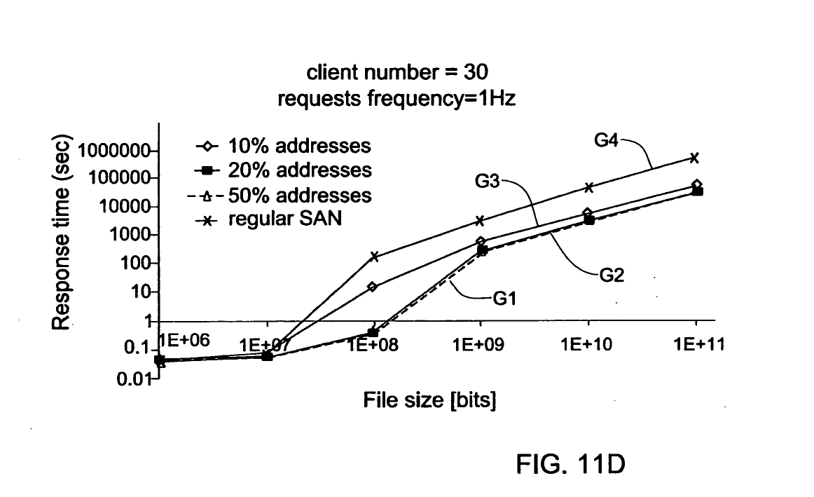

Reference is now made to FIGS. 11A-11D, showing network response time as a function of file size for the communication network of the invention with 10 (FIG. 11A-11B) and 30 (FIGS. 11C-11D) clients, and with a request frequency of 0.5 Hz (FIGS. 11A and 11C) and 1 Hz (FIGS. 11B and 11D). Each of these figures show graphs G1-G4 corresponding to functions similar to those of FIGS. 9A-9F and FIGS. 10A-10C.

For small file sizes, it can be seen that for all three configurations of the invention (graphs G1-G3) and the regular SAN architecture (graph G4), the response times converge to approximately a constant. This state remains for files up to 10 Mbits. For files larger than 10 Mbits, the response time increases for all of the networks. This change is more gradual for the network architecture of the invention (graphs G1-G3) whereas for the regular SAN (graph G4) this change is more abrupt. At a file size between 100 Mbits and 1 Gbits, the slope of the regular SAN′ curve reduces, and the network behavior remains a linear constant for all file sizes thereafter, i.e. remains a power-law. The network configurations of the invention start to behave as a power law function at file size of around 1 Gbits, arriving to the slope in a log-log scale similar to that of the regular SAN.

Thus, the present invention provides novel communication network architecture for data transfer and a server system for managing the data transfer in this network. Those skilled in the art will readily appreciate that various modifications and changes can be applied to the embodiments of the invention as hereinbefore described without departing from its scope in and by the appended claims.

1. A communication system for managing data transfer via a communication network, the communication system comprising: a first management network for connecting a plurality of client systems to a server utility, a second data network for directly connecting the client systems between them, comprises and a server system which is associated with said server utility and is thus connected to a plurality of the client systems via the first management network, said server system being configured and operable to be responsive to data pieces from the client systems via said first management network to selectively switch between first and second modes of operation, the first operational mode of the server system comprising managing and executing data transfer to and from the client systems through the first management network and the second operational mode of the server system comprising managing direct data transfer between the client systems via the second data network by creating task dedicated dynamical circuits which physically connect the client systems enabling them to communicate directly with each other.

2. A system of claim 1, wherein the server system comprises:
a manager utility for managing communication between the multiple client systems via said first and second networks of said communication network, the manager utility comprising:
a data receiver module for receiving data pieces from the client systems, and
an analyzer module for analyzing each of the received data pieces and identifying whether the data piece corresponds to either one of first and second data types to be treated by either one of the first and second operational modes of the server system with respect to transfer of data corresponding to said data pieces through the communication network, such that in the first operation mode, the server operates to transmit main data corresponding to the data piece through said first management network according to a network address embedded in said data piece, and in the second operational mode the server operates to initiate transfer of main data corresponding to said data piece via the second data network connected to said first management network;
a data network controller configured and operable to be responsive to output of the analyzer module to establish assignment of the main data to be transferred to a dedicated channel in said second data network.

3. The system of claim 2, wherein the server communication with the client system utilizes a permanent address of the client system in said first management network, and the server system manages communication between the clients via the second data network using provisional circuits assigned to the client systems in the second data network.

4. The system of claim 2, wherein said data network controller is configured and operable to establish the assignment of the main data to the dedicated channel by assignment of a data network provisional circuit to a source client system and a destination client system, thereby allowing said direct communication between them.

5. The system of claim 4, wherein said data network controller is configured and operable to establish the assignment of said data network provisional circuit in a static mode, such that each client system connected to said server system has its pre-assigned address to be used in creation of a provisional circuit with respect to another client system.

6. The system of claim 4, wherein said data network controller is configured and operable to establish the assignment of said data network provisional circuit in a dynamic mode in response to the received data piece, for the transfer of the main data corresponding to said data piece and releasing the previously assigned provisional circuit after completion of said transfer of the main data.

7. The system of claim 6, wherein said data network controller is responsive to a notification regarding said transfer of data, for releasing a previously assigned data network provisional circuit after completion of said transfer of the main data.

8. The system of claim 2, wherein said data network controller is configured and operable for controlling data transmission via an additional dedicated network connecting some of the network client systems.

9. The system of claim 2, wherein said analyzer module identifies whether said received data piece corresponds to either one of the first and second data types according to at least one predetermined condition including a condition corresponding to a volume of the main data, which in accordance with said received data piece, is to be transferred.

10. (canceled)

11. The system of claim 1, said first management network is configured as a storage area network, at least some of the client systems comprising data storage utilities.

12. The system of claim 1, wherein said second data network is configured as a multi channel network capable of parallel transmission of different pieces of main data between different client systems of the communication network.

13. The system of claim 1, wherein said data network comprises at least one of a static addressing network and a dynamic addressing network, in which the server system is configured and operable to assign an address to the client system in the second data network.

14. (canceled)

15. The system of claim 1, wherein said data network is an optical communication network.

16. The system of claim 15, wherein said optical communication network comprises an optical fiber network, the main data being transferred between the client systems by wavelength addressing.

17. The system of claim 15, wherein said optical communication network comprises a bundle of optical fibers, an address assigned to a client system being constituted by a selected wavelength-fiber pair.

18. (canceled)

19. A communication device connectable to a communication network via a server system, the communication device comprising:
an electronic utility comprising: a port configured for connecting to a first management network of the communication network, a processor utility, a memory utility; and
receiver and transmitter modules configured for receiving and transmitting data to and from a second data network of said communication network;
said processor utility of the electronic utility being preprogrammed for selectively transmitting or receiving data via the first or second networks according to a notification message received at the electronic utility through the first network.

20. The device of claim 19, wherein said receiver and transmitter modules communicate via said data network according to an assigned thereto data network address corresponding to a provisional circuit to be used by said device to directly communicate with another device via the data network, said address may be static or dynamic.

21. The device of claim 19, wherein said receiver and transmitter modules are assigned with a provisional circuit in response to said notification message.

22. The device of claim 19, wherein said receiver and transmitter modules are connectable to said data network being an optical data network, the device comprising a wavelength allocation module for selectively transmitting optical signal in a predetermined wavelength range, said receiver module selectively receiving optical signals in said wavelength range.

23. (canceled)

24. The device of claim 19, wherein said electronic utility comprises a manager utility preprogrammed for prioritizing different data transfer sessions relating to different notification messages to execute said data transfer sessions through either the management network or the data network according to a predetermined scheme.

25. The device of claim 19, wherein said transmitter and receiver modules are configured and preprogrammed for dynamically allocating a data network provisional circuit according to online circuit switching scheme.

26. The device of claim 22, characterized by at least one of the following: (1) further comprises a tunable light source for transmitting optical radiation in a wavelength determined by said processor utility, via said data network; (2) the wavelength allocation module is connected to an optical power grid, and operates to input optical radiation from said optical power grid in a wavelength which corresponds to said notification message.

27. (canceled)

28. A method for managing data transfer through a communication network, the method comprising:
receiving data from a remote communication device via said communication network, identifying whether the received data satisfies at least one predetermined condition, and classifying the data accordingly, said at least one predetermined condition including a threshold value for a volume or security criteria of main data;
based on said classifying, generating a corresponding notification message to said remote communication device indicative of a manner in which main data, corresponding to said received data, is to be transmitted by the communication device, thereby enabling selective transmission of the main data via first or second networks of said communication network.
